(19) United States
(12) Patent Application Publication
(10) Pub. No.: US 2009/0172135 A1
(43) Pub. Date: Jul. 2, 2009

(54) PRE-BOOT RETRIEVAL OF AN EXTERNAL BOOT FILE

(76) Inventors: Paul Carbin, Albuquerque, NM (US); Grant Fraser, Auburn, CA (US); Ajith Illendula, Albuquerque, NM (US)

Correspondence Address: Schwabe, Williamson & Wyatt, PC;Pacwest Center, Suites 1600-1900, 1211 SW Fifth Ave.,, Portland, OR, 97204, US

(21) Appl. No.: 11/968,069

(22) Filed: Dec. 31, 2007

(51) Int. Cl. G06F 15/177

(52) U.S. Cl. 709/222

(57) ABSTRACT

Embodiments of methods for more securely booting an apparatus into an operational mode, using a boot file disposed in a network boot server are disclosed herein. In embodiments, the name and location of the boot file is placed into a storage location of a manageability engine of an apparatus. The manageability engine is separated from the application execution environment of the apparatus.

### TECHNICAL FIELD

Embodiments of the present invention relate to the field of data processing, in particular, to methods and apparatuses for pre-boot retrieval of an external boot file.

### BACKGROUND

Advances in integrated circuit and other related technologies have led to the proliferation and wide spread adoption of personal computing, presenting major management challenges to Information Technology (IT) organizations. Further, advances in networking and other related technologies have led to increase in networked computing, client-server for some or peer-to-peer for others. With increased connectivity, computing system/device manufacturers have started designing and producing systems/devices that can be managed remotely across a network. Recently, manufacturers have also designed and produced computing systems and devices that are shipped “naked,” without an operating system or a boot file pre-loaded. The computing systems/devices are configured to obtain the boot file from a remotely disposed network boot server.

Typically, such a computer system/device first discovers and obtains an Internet Protocol (IP) address from a proxy server, e.g. a DHCP server (DHCP=Dynamic Host Configuration Protocol). The proxy server on discovering that the computer system/device is also looking for a boot file, would offer the computer system/device, the location of a boot server and the name of a boot file on the boot server. On receipt, the computer system/device would retrieve the boot file from the boot server, and boot into operation using the boot file. This current approach is inherently insecure, and is a concern to many enterprises.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 is a block diagram illustrating an overview of the present invention, in accordance with various embodiments;

FIGS. 2 and 3 are flow charts of selected operations of BIOS of FIG. 1 to retrieve the name of the boot file and the location of the boot server from a local out-of-band accessible storage location, in accordance various embodiments of the present invention; and

FIG. 4 is an exemplary computer system/device suitable for practicing the present invention, in accordance with various embodiments.

### DETAILED DESCRIPTION OF ILLUSTRATIVE EMBODIMENTS

Illustrative embodiments of the present invention include, but are not limited to, methods and apparatuses for more securely retrieving a boot file from an external remotely disposed boot server, prior to booting an apparatus into operation.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A and/or B” means “(A), (B), or (A and B)”. The phrase “A/B” means “(A), (B), or (A and B),” similar to the phrase “A and/or B”. The phrase “at least one of A, B and C” means “(A), (B), (C), (A and B), (A and C), (B and C) or (A, B and C)”. The phrase “(A) B” means “(B) or (A B)”, that is, A is optional.

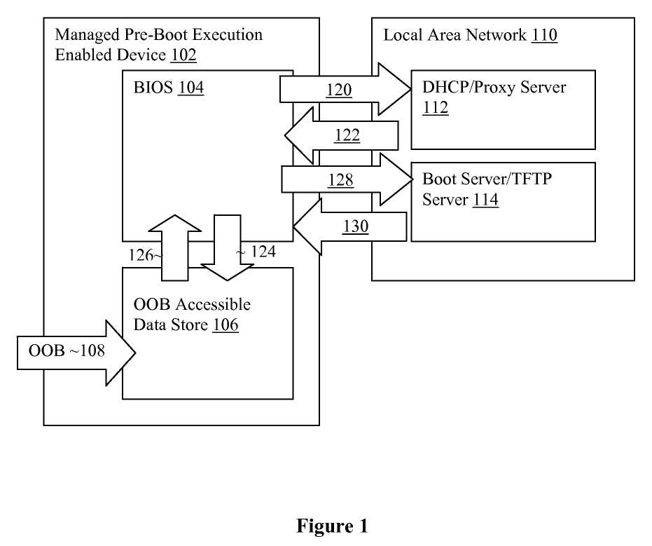

FIG. 1 illustrates an overview of the present invention, in accordance with various embodiments. As illustrated, device 102 enabled with managed pre-boot execution environment is endowed with basic input/output service (BIOS) 104 and a data storage area 106. The data storage area 106 is configured for out-of-band access, even when device 102 is not in an operation mode. Thus, the manufacturer or a trusted third party is able to store into storage area 106, at least the name of a boot file and the location of a boot server where the boot file is located, even when device 102 is not in operation.

BIOS 104 is configured to discover 120 at power on, proxy servers 112 on a network, e.g. local area network 110, and obtain 122 a networking address, such as an IP address from proxy server 1 12. In various embodiments, proxy server 112 may be a DHCP server.

However, for these embodiments, unlike the prior art, BIOS 104 does not indicate to proxy server 112 that it is also looking for a boot file. Instead, BIOS 104 is configured to access 124 the out-of-band accessible data storage area 106, and retrieve from storage area 106, the location of the boot server and the name of the boot file on the boot server (pre-stored therein by the manufacturer or a trusted third party, via the out-of-band access, as earlier described).

Thereafter, on retrieval of the name of the boot file, and the location of the boot server, BIOS 104 then accesses 128 boot server 114 and retrieves 130 the boot file. In various embodiments, BIOS 104 may retrieve the boot file in accordance with a file transfer protocol, e.g. the trivial file transfer protocol (TFTP). On retrieval, BIOS 104 causes device 102 to boot into the operation mode using the boot file.

Thus, by restricting the out-of-band access to only the manufacture or a trusted third party, such booting using a dynamically retrieved remote boot file may become more secure. In other embodiments, device 102 may be assigned a static network (e.g. IP) address, negating the need for BIOS 104 to perform the discovery and obtain network address operations.

Before proceeding to describe retrieval of the boot file name and the location of the boot server from local out-of-band accessible storage area 106, it should be noted that BIOS 104, in addition to the teachings of the invention, may further be configured for other conventional or non-conventional functions. Storage area 106 may be any one of a number of out-of-band accessible storage.

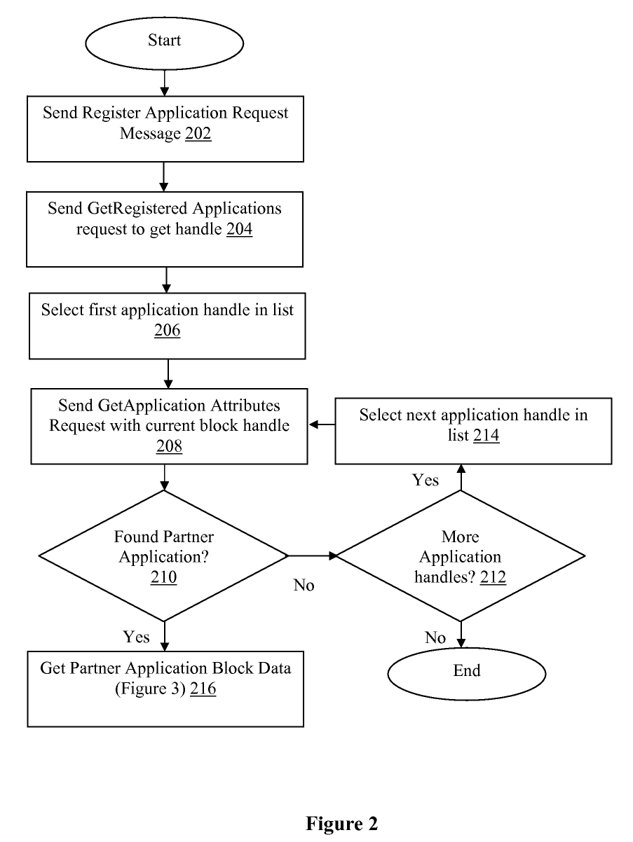

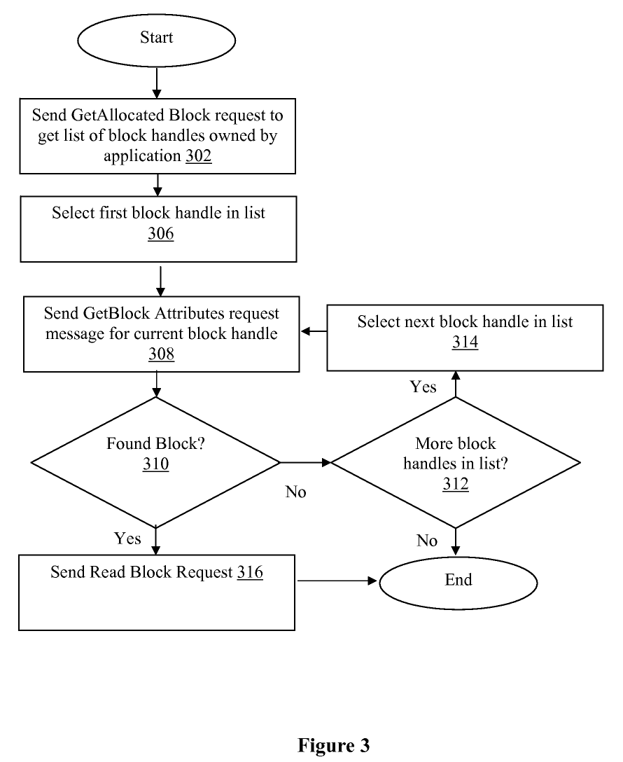

FIGS. 2 and 3 illustrate retrieval of the name of the boot file and the location of the boot server, in accordance with various embodiments, more specially, embodiments that support a hardware embedded controller interface (HECI) messaging protocol. The messaging protocol includes in particular, the following messages
messages to start the process for obtaining data associated with registered applications (Register Application);
messages to request handles of registered applications (GetRegistered Application);
messages to obtain application attributes associated with an application block handle (GetApplication Attributes);
messages to obtain allocated blocks of a registered application (GetAllocated Block);
messages to obtain attributes of an allocated block (GetBlock Attributes);
messages to read data stored in a block (Block Read).

As illustrated, BIOS 104 first sends a Register Application request message 202 to initiate the process to obtain data associated with registered applications. Next BIOS 104 sends a GetRegistered Applications to get a list of handles of the registered applications, 204.

At 206, BIOS 104 selects the first application handle in the obtained list. Then BIOS 104 sends a GetApplication Attributes request with the current block handle to obtain application attributes associated with the application corresponding to the current block handle. At 210, BIOS 104 determines if the partner application is found. If the partner application has not been found yet, BIOS 104 determines whether there are more application handles still to be attempted, 212. If so, BIOS 104 selects 214 the next application handle in the list and continues back at block 208. However, if all application handles have been attempted, the processing terminates on an exception. On the other hand, if a partner application is found at block 210, BIOS 104 proceeds to obtain 216 the partner application's block data comprising the name of the boot file, and the location of the boot server.

For the embodiments illustrated, at 302, BIOS 104 sends a GetAllocated Block request to get list of block handles owned by the registered application 302. Then BIOS 104 selects the first block handle in the list, 306, and sends a GetBlock Attributes request message for the current block, 308. If the desired block is not found, BIOS 104 determines whether there are more block handles in the list, 312. If so, BIOS 104 selects the next block handle in the list, 314, and proceeds with block 308. If all blocks have been attempted, BIOS 104 terminates the processing abnormally.

Back at block 310, if the desired block is found, BIOS 104 issues a Block Read request to read the block to obtain the name of the boot file and the location of the boot server.

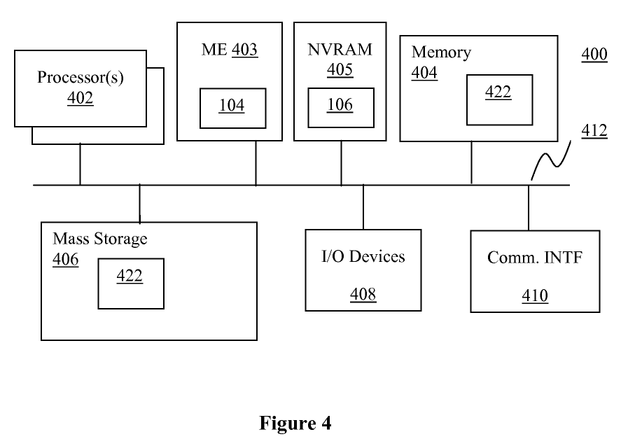

FIG. 4 illustrates an example computer system suitable for use to practice various embodiments of the present invention. As shown, computing system 400 includes one or more processors 402, manageability engine 403, non-volatile memory (NVRAM) 405 and system memory 404. Additionally, computing system 400 includes mass storage devices 406 (such as diskette, hard drive, CDROM and so forth), input/output devices 408 (such as keyboard, cursor control and so forth) and communication interfaces 410 (such as network interface cards, modems and so forth). The elements are coupled to each other via system bus 412, which represents one or more buses. In the case of multiple buses, they are bridged by one or more bus bridges (not shown).

Each of these elements performs its conventional functions known in the art. In particular, manageability engine 403 may comprise the earlier described out-of-band accessing storage location 106, and NVRAM 405 may comprise BIOS 104 endowed with the ability to retrieve the file name of a boot file and the location of the boot server from storage location 106. In various embodiments, BIOS 104 may also be endowed with the logic to discover the proxy server, obtain an IP address from the proxy server, and to retrieve the boot file, based on the name and the location of the boot server retrieved from the out-of-band accessible local storage.

BIOS 104 may be placed into manageability engine 401 in the factory, or in the field, through, for example, a distribution medium (not shown), such as a compact disc (CD), or through communication interface 410 (from a distribution server (not shown)).

The constitution of these elements 402-412 are known, and accordingly will not be further described.

In various embodiments, computer system 400 may be a server, a desktop computer, a laptop computer, a tablet computer or a smart phone. In other embodiments, computer system 400 may also be embedded in a media player, a game console, a set-top box, or a digital recorder.

In embodiments of the present invention (not illustrated), an article of manufacture may be employed to implement one or more methods as disclosed herein. For example, in exemplary embodiments, an article of manufacture may comprise a storage medium and a plurality of programming instructions stored in the storage medium, the programming instructions configured to enable an apparatus to retrieve a name and an external location of a boot file from a storage location of the apparatus and retrieve the boot file from the external location before the apparatus is booted into an operational mode. In embodiments, the storage location may be accessible via an out-of-band path for storing the name and external location of the boot file even when the apparatus is not in the operational mode.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

1. An article of manufacture comprising:
a storage medium; and
a plurality of programming instructions stored in the storage medium, the programming instructions configured to enable an apparatus to retrieve a name and an external location of a boot file from a storage location of the apparatus and retrieves the boot file from the external location before the apparatus is booted into an operational mode, the storage location being accessible via an out-of-band path for storing of the name and external location of the boot file even when the apparatus is not in the operational mode.

2. The article of claim 1, wherein the programming instructions are configured to further enable the apparatus to cause the booting of the apparatus into the operational mode using the boot file upon receipt of the boot file.

3. The article of claim 1, wherein the programming instructions are configured to enable the apparatus to retrieve the name and the external location of the boot file from a storage location disposed within a manageability engine of the apparatus, the manageability engine being separated from an application execution environment of the apparatus.

4. The article of claim 3, wherein the programming instructions are configured to enable the apparatus to issue messages in accordance with an embedded controller message protocol to retrieve the name and the external location of the boot file from the storage location disposed within the manageability engine of the apparatus.

5. The article of claim 1, wherein the programming instructions are configured to further enable the apparatus to obtain an Internet Protocol (IP) address for the apparatus, from a network server, prior to the apparatus having been booted into the operational mode.

6. The article of claim 5, wherein the programming instructions are configured to enable the apparatus to retrieve a filename and an IP address of an external boot server for the boot file from the storage location of the apparatus.

7. The article of claim 6, wherein the programming instruction are configured to enable the apparatus to retrieve the boot file from the external boot server using the filename and IP address of the external boot server, in conjunction with a file transfer protocol.

8. A method comprising:
placing a boot file on a boot server disposed on a network; and
placing a name of the boot file and network location information of the boot server in a storage location of an apparatus, via an out-of-band communication path, while the apparatus is not in an operational mode, to enable the apparatus to retrieve the boot file from the boot server and boot the apparatus into the operational mode using the boot file in a next system boot.

9. The method of claim 8, wherein the placing of a name of the boot file and network location information of the boot server in a storage location of an apparatus comprises placing the name of the boot file and network location information of the boot server in a storage location disposed in a manageability engine of the apparatus, the manageability engine being separate from an application execution environment of the apparatus.

10. The method of claim 8, wherein the placing of a name of the boot file and network location information of the boot server in a storage location of an apparatus comprises placing a filename of the boot file and an Internet Protocol (IP) address of the boot server in the storage location.

11. The method of claim 8, further comprising responding to the apparatus and providing the apparatus with the boot file when requested by the apparatus.

12. The method of claim 8, wherein the responding and providing the boot file when requested comprises responding and providing in accordance with a file transfer protocol.
